(19) United States
(12) Patent Application Publication
(10) Pub. No.: US 2017/0238122 A1
(43) Pub. Date: Aug. 17, 2017

(54) USER EQUIPMENT REGISTRATION METHOD, ENTITY, SYSTEM AND COMPUTER STORAGE MEDIUM

(71) Applicant: ZTE Corporation, Shenzhen, Guangdong (CN)

(72) Inventor: Kun Yang, Shenzhen (CN)

(21) Appl. No.: 15/502,837

(22) PCT Filed: Feb. 26, 2015
(86) PCT No.: PCT/CN2015/073298

§ 371 Date: Feb. 9, 2017

(30) Foreign Application Priority Data
Aug. 12, 2014 (CN) 201410395748.6

(51) Int. Cl. H04W 4/00; H04W 8/08; H04W 12/06

(52) U.S. Cl. CPC H04W 4/005; H04W 12/06; H04W 8/082

(57) ABSTRACT

Disclosures are a user equipment (UE) registration method, entity, system and a computer storage medium. The method comprises: a common service entity (CSE) in a UE sending an equipment registration request to a machine type communication-inter working function entity (MTC-IWF), wherein the equipment registration request contains an identifier of the UE in an underlying network, an application port identifier of the UE, an identifier of a machine-to-machine/man (M2M) service provider subscribed to by the UE, and an identifier of an application entity (AE) of the M2M service provider.

### TECHNICAL FIELD

The disclosure relates to the management technology of a terminal in a machine type communication (MTC) in the field of the terminal communications, and in particular to a user equipment (UE) registration method, entity, system and computer storage medium.

### BACKGROUND

The machine-to-machine/man (M2M) communication system is constituted by respective M2M nodes and an underlying network. The communication between M2M nodes is realized through the underlying network. A M2M node at least includes an application entity (AE) or a common service entity (CSE). The AE is a logic unit for executing the actual M2M application, and the CSE a logic unit for managing and serving the application. The underlying network services entity (NSE) provides services of equipment management, position serving, equipment triggering etc. for the CSE. The NSE is, for example, a home subscriber server (HSS), or a MTC inter working function (MTC-IWF) entity, etc.

The communication between the M2M applications is realized through the interaction of CSEs. The registration of the M2M to the CSE and the registration between the CSEs are needed, so as to realize the interaction of the M2M application through the communication between the CSE. A M2M system architecture is shown in FIG. 1. In the M2M system architecture, an application node is an execution node at end of the M2M system, such as an intelligent electric meter, a temperature measurement and control sensor, a fire alarm, and an intelligent appliance etc.; a middle node (MN) is a middle element connecting the end execution node to a network side server, such as a gateway; an infrastructure node (IN) is a server at the network side, the application registered in the IN can be a management platform of the M2M service provider (SP), and the binding relationship between the M2M node and the identifier of the CSE, the identifier in the underlying network is maintained by the M2M SP.

The application node can be categorized into two types according to differences in functions: a node including the CSE and a node not including the CSE. For example, an application dedicated node (ADN) at least includes a AE, not including the CSE; and an application service node (ASN) at least includes a AE and a CSE, and the ASN or MN is physically corresponding to the UE.

In actual application, when creating, retrieving, updating or deleting operation is executed, by the application entity registered in the infrastructure node, on resources in the UE, the connection between the CSE on the ASN and the CSE in the IN is triggered to be created, or the connection between the CSE on the MN and the CSE in the IN is triggered to be created, as the server on the network side, a triggering message is transmitted through the underlying network, and the following information is provided, by the server, to the underlying network so as to trigger the UE:

1) a M2M external identifier (M2M-Ext-ID): arranged to identify the target UE of a triggering request;

2) a triggering message recipient identifier (Trigger-Recipient-ID): arranged to be the identifier for routing the triggering message to a target ASN/MN-CSE in the UE;

3) a IN-CSE identifier.

The M2M external identifier serves as one of the necessary information provided by the server to the underlying network for triggering the UE. However, in related art, there is not any effective mechanism for the IN-CSE to obtain the M2M-Ext-ID. The process of triggering the UE thus cannot be performed.

### SUMMARY

The disclosure is intended to provide a user equipment (UE) registration method, entity, system and a computer storage medium, enabling the network side server to obtain a M2M external identifier of the UE, so as to realize the triggering of the UE by the server.

The technical solution of the disclosure is implemented as follows.

An embodiment of the disclosure provides a user equipment (UE) registration method, which includes: sending, by a common service entity (CSE) in the UE, an equipment registration request to a machine type communication inter-working function entity (MTC-IWF), in which the equipment registration request includes an identifier of the UE in an underlying network, an application port identifier of the UE, an identifier of a machine-to-machine/man (M2M) service provider subscribed to by the UE, and an identifier of an application entity (AE) of the M2M service provider.

An embodiment of the disclosure further provides a CSE set in the UE, in which the CSE includes:

a registration requesting unit, arranged to generate an equipment registration request; and

a first sending unit, arranged to send the registration request to the MTC-IWF, the registration request including an identifier of the UE in the underlying network, an application port identifier of the UE, an identifier of the M2M service provider subscribed to by the UE, and an identifier of the AE of the M2M service provider.

An embodiment of the disclosure further provides a MTC-IWF, which includes:

a first receiving unit, arranged to receive a registration request sent by the CSE in the UE; and

an analyzing unit, arranged to analyze the identifier of the UE in the underlying network, the application port identifier of the UE, the identifier of the M2M service provider subscribed to by the UE, and the identifier of the AE of the M2M service provider, included in the equipment registration request.

An embodiment of the disclosure further provides a CSE set in a server in which the UE is registered, in which the CSE includes:

a third receiving unit, arranged to receive a registration request sent by the MTC-IWF;

an authenticating unit, arranged to authenticate the UE; and

a fourth sending unit arranged to, after the authentication of the authenticating unit is passed, send the registration request to the AE according to the identifier of the AE, in which the registration request sent by the fourth sending unit includes the M2M external identifier of the UE and the application port identifier of the UE.

An embodiment of the disclosure further provides a registration system, which includes: a MTC-IWF, a CSE set in the UE and a AE of the M2M service provider subscribed to by the UE;

the CSE set in the UE is arranged to send a registration request to the MTC-IWF, in which the registration request includes an identifier of the UE in the underlying network, an application port identifier of the UE, an identifier of the M2M service provider subscribed to by the UE, and an identifier of the AE of the M2M service provider; and

the MTC-IWF is arranged to receive the equipment registration request.

An embodiment of the disclosure further provides a computer storage medium which stores computer executable instructions used for executing the registration method of the UE.

In the disclosure, the equipment registration request is sent to the MTC-IWF by the CSE in the UE, the registration request including the identifier of the UE in the underlying network, the application port identifier of the UE, the identifier of the M2M service provider subscribed to by the UE, and the identifier of the AE of the M2M service provider. Thus, the M2M external identifier of the UE can be requested from the HSS by the MTC-IWF according to the identifier of the UE in the underlying network and the identifier of the M2M service provider subscribed to by the UE, and the M2M external identifier of the UE can be obtained by the CSE in the server in subsequent registration process, so as to finish the registration process of the UE and realize the triggering of the UE by the server.

### BRIEF DESCRIPTION OF THE DRAWINGS

FIG. 1 is a schematic diagram of a M2M system architecture.

FIG. 2 is a schematic diagram of a registration method according to an embodiment of the disclosure.

FIG. 3 is a structural diagram of a CSE in UE.

FIG. 4a is a structural diagram 1 of a MTC-IWF according to an embodiment of the disclosure.

FIG. 4b is a structural diagram 2 of a MTC-IWF according to an embodiment of the disclosure.

FIG. 4c is a structural diagram 3 of a MTC-IWF according to an embodiment of the disclosure.

FIG. 4d is a structural diagram 4 of a MTC-IWF according to an embodiment of the disclosure.

FIG. 4e is a structural diagram 5 of a MTC-IWF according to an embodiment of the disclosure.

FIG. 4f is a structural diagram 6 of a MTC-IWF according to an embodiment of the disclosure.

FIG. 5a is a structural diagram 1 of a CSE set in a server to which a AE is registered according to an embodiment of the disclosure.

FIG. 5b is a structural diagram 2 of a CSE set in a server to which a AE is registered according to an embodiment of the disclosure.

FIG. 5c is a structural diagram 3 of a CSE set in a server to which a AE is registered according to an embodiment of the disclosure.

FIG. 6a is a structural diagram 1 of a registration system according to an embodiment of the disclosure.

FIG. 6b is a structural diagram 2 of a registration system according to an embodiment of the disclosure.

FIG. 6c is a structural diagram 1 of a registration system according to an embodiment of the disclosure.

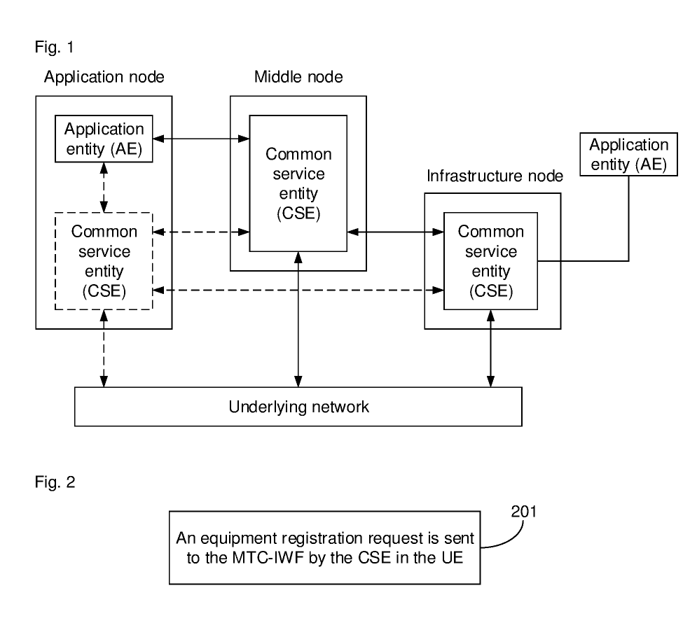

### DETAILED DESCRIPTION

The purpose, technical solutions and advantages of the disclosure will be more clear and definite through the further description of the disclosure below with reference to the drawings and embodiments. It should be noted that the embodiments described here are used for illustrating the disclosure only, not limiting.

As shown in FIG. 2, an embodiment of the disclosure provides a registration method, which includes the following steps:

Step 201: an equipment registration request is sent to the MTC-IWF by the CSE in the UE. The registration request includes an identifier of the UE in the underlying network, an application port identifier of the UE, an identifier of the M2M service provider subscribed to by the UE, and an identifier of the AE of the M2M service provider.

In an embodiment, when the equipment registration request is received by the MTC-IWF, the method further includes: a subscription information request is sent to the HSS by the MTC-IWF. The subscription information request includes the identifier of the UE in the underlying network and the identifier of the M2M service provider.

In an embodiment, when the subscription information request is received by the HSS, the method further includes: a M2M external identifier of the UE is retrieved by the HSS according to the identifier of the UE in the underlying network and the identifier of M2M service provider, and then the M2M external identifier of the UE is fed back to the MTC-IWF through a subscription information response.

In an embodiment, when the subscription information response is received by the MTC-IWF, the method further includes: a registration request is sent to the CSE in the server by the MTC-IWF according to the identifier of the CSE in the server to which the AE is registered. The registration request includes the M2M external identifier of the UE, the application port identifier of the UE and the identifier of the AE.

In an embodiment, when the registration request is received by the CSE in the server, the method further includes: the UE is authenticated by the CSE in the server, and after the authentication is passed, the registration request is sent to the AE according to the identifier of the AE. The registration request includes the M2M external identifier of the UE and the application port identifier of the UE.

In an embodiment, when the registration request is received by the AE, the method further includes: the UE is verified by the AE, after the verification is passed, the binding relationship between the M2M external identifier of the UE, the application port identifier of the UE and the identifier of the CSE in the UE is determined, the registration response is sent to the CSE in the server. The registration response includes the binding relationship.

In an embodiment, when the registration response is received by the CSE in the server, the method further includes: the binding relationship and a state information of the UE are cached in the CSE of the server, an equipment registration response is sent to the UE by the MTC-IWF. The registration response includes the identifier of the CSE in the server.

In an embodiment, when the equipment registration request is received by the MTC-IWF, the method further includes: the subscription information request is sent to the HSS by the MTC-IWF. The subscription information request includes the identifier of the UE in the underlying network, the identifier of M2M service provider and the identifier of the CSE in the server to which the AE is registered.

In an embodiment, when the subscription information request is received by the HSS, the method further includes: the M2M external identifier and a routing information of the UE are retrieved by the HSS according to the identifier of the UE in the underlying network and the identifier of M2M service provider, the authentication of the CSE in the server is searched according to the identifier of the CSE in the server, and the M2M external identifier of the UE, the routing information of the UE and the authentication of the CSE in the server are fed back to the MTC-IWF through the subscription information response.

In an embodiment, when the subscription information response is received by the MTC-IWF, the method further includes:

the routing information of the UE and the authentication of CSE in the server are cached in the MTC-IWF, the registration request is sent to the CSE in the server by the MTC-IWF according to the identifier of the CSE in the server. The registration request includes the M2M external identifier of the UE, the application port identifier of the UE and the identifier of the AE.

In an embodiment, when the registration request is received by the CSE in the server, the method further includes:

the UE is authenticated by the CSE in the server, after the authentication is passed, the registration request is sent to the AE according to the identifier of the AE. The registration request includes the M2M external identifier of the UE and the application port identifier of the UE.

In an embodiment, when the registration request is received by the AE, the method further includes:

the UE is verified by the AE, after the verification is passed, the binding relationship between the M2M external identifier of the UE, the application port identifier of the UE and the identifier of the CSE in the UE is determined, the registration response is sent to the CSE in the server. The registration response includes the binding relationship.

In an embodiment, when the registration response is received by the CSE in the server, the method further includes:

the binding relationship and the state information of the UE are cached in the CSE of the server, the equipment registration response is sent to the UE by the MTC-IWF. The registration response includes the identifier of the CSE in the server.

In an embodiment, when the equipment registration response is sent, by the CSE of the server, to the UE via the MTC-IWF, the method further includes:

a resource operation request is sent to the CSE of the server by the AE, the resource operation request includes the identifier of CSE in the UE.

In an embodiment, after the resource operation request is received by the CSE of the server, the method further includes:

the state information of the UE is checked by the CSE of the server according to the identifier of the CSE in the UE, and an equipment triggering request is sent to the MTC-IWF. The equipment triggering request includes the M2M external identifier of the UE, the application port identifier of the UE and the identifier of the CSE in the server.

In an embodiment, after the equipment triggering request is received by the MTC-IWF, the method further includes:

the authentication of the CSE, the identifier and routing information of the UE in the underlying network are requested, by the MTC-IWF, from the HSS according to the identifier of CSE in the sever and the M2M external identifier of the UE, or the authentication of the CSE, the identifier and routing information of the UE in the underlying network are searched for according to the identifier of CSE in the sever and the M2M external identifier of the UE; and

a triggering process is executed in the underlying network according to the authentication of the CSE, the identifier and routing information of the UE in the underlying network, and an equipment triggering request receipt confirmation is fed back to the CSE in the sever.

An embodiment of the disclosure further discloses a computer storage medium for storing computer executable instructions, which are used for executing the registration method shown in FIG. 2.

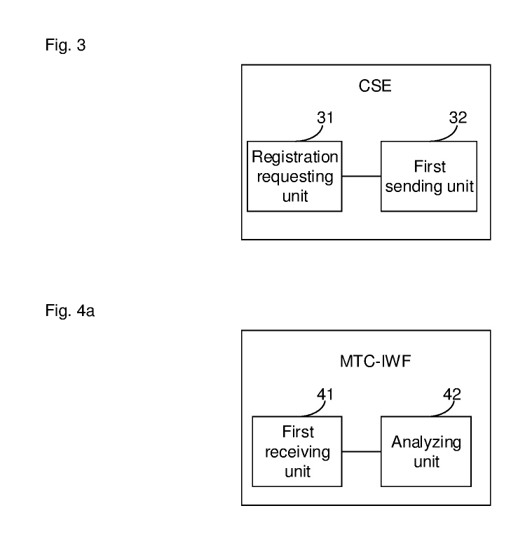

An embodiment of the disclosure further discloses a CSE set in the UE, as shown in FIG. 3. The CSE includes:

a registration requesting unit 31, arranged to generate an equipment registration request;

and a first sending unit 32, arranged to send the registration request to the MTC-IWF, and the registration request includes an identifier of the UE in the underlying network, an application port identifier of the UE, an identifier of the M2M service provider subscribed to by the UE, and an identifier of the AE of the M2M service provider.

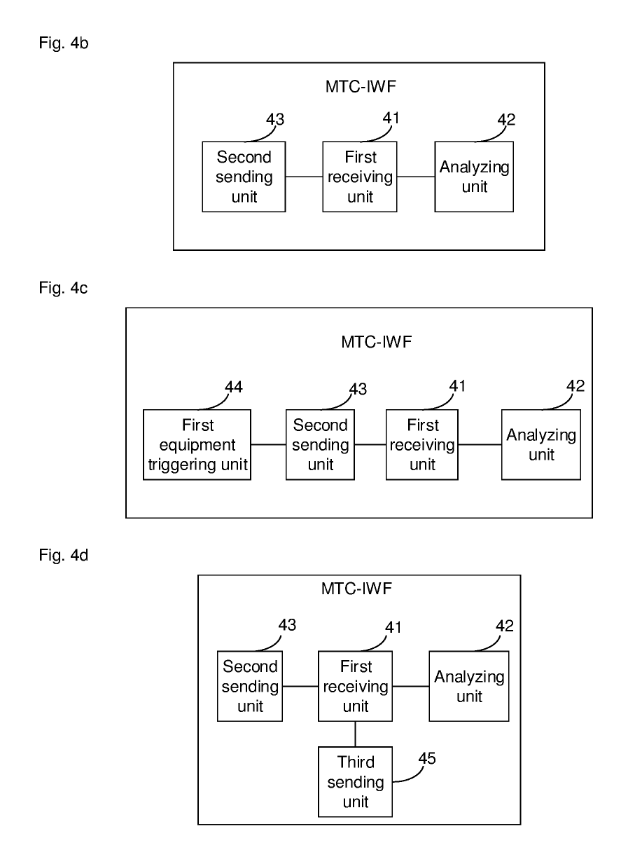

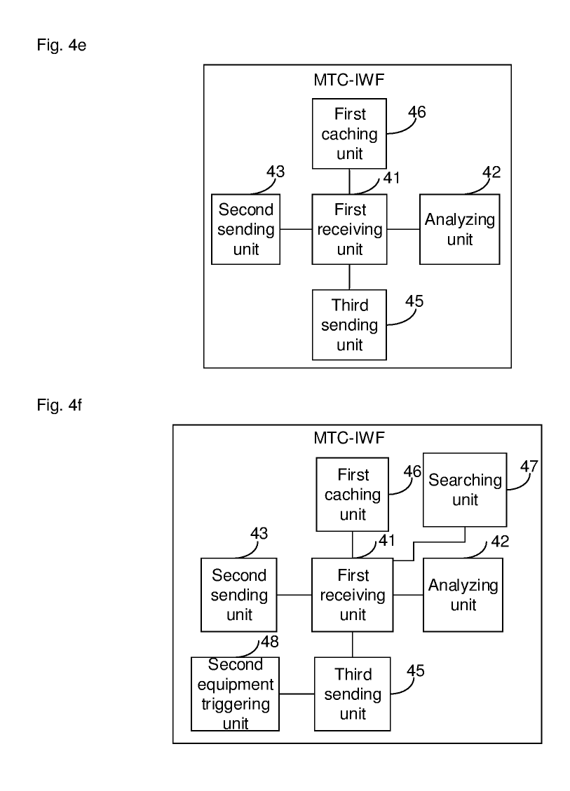

An embodiment of the disclosure further discloses a MTC-IWF, as shown in FIG. 4a, and the MTC-IWF includes:

a first receiving unit 41, arranged to receive the registration request sent by the CSE is in the UE;

and an analyzing unit 42, arranged to analyze the identifier of the UE in the underlying network, the application port identifier of the UE, the identifier of the M2M service provider subscribed to by the UE, and the identifier of the AE of the M2M service provider, included in the equipment registration request.

In an embodiment, as shown in FIG. 4b and based on the FIG. 4a, the MTC-IWF further includes:

a second sending unit 43, arranged to send a subscription information request to the HSS when the equipment registration request is received by the first receiving unit 41. The subscription information request includes the identifier of the UE in the underlying network and the identifier of M2M service provider.

Preferably, the first receiving unit 41 is further arranged to receive a subscription information response sent by the HSS. The subscription information response is generated when the subscription information request is received by the HSS. The subscription information response includes the M2M external identifier of the UE retrieved by the HSS according to the identifier of the UE in the underlying network and the identifier of M2M service provider.

Preferably, the second receiving unit 43, is further arranged to when the subscription information response is received by the first receiving unit 41, send a registration request to the CSE in the server according to the identifier of the CSE in the server to which the AE is registered. The registration request includes the M2M external identifier of the UE, the application port identifier of the UE and the identifier of the AE.

In an embodiment, as shown in FIG. 4c and based on the FIG. 4b, the MTC-IWF further includes a first equipment triggering unit 44;

the first receiving unit 41 is further arranged to receive an equipment triggering request sent by the CSE in the server. The equipment triggering request includes the M2M external identifier of the UE, the application port identifier of the UE and the identifier of the CSE in the server;

the second receiving unit 43 is further arranged to feed back an equipment triggering request receipt conformation to the CSE in the server; and

the first equipment triggering unit 44 is arranged to execute the equipment triggering process in the underlying network according to the authentication of the CSE, the identifier and routing information of the UE in the underlying network.

In another embodiment, as shown in FIG. 4d and based on the FIG. 4b, the MTC-IWF further includes:

a third sending unit 45, arranged to send a subscription information request to the HSS when the equipment registration request is received by the first receiving unit 41. The subscription information request includes the identifier of the UE in the underlying network, the identifier of M2M service provider and the identifier of the CSE in the server to which the AE is registered;

the first receiving unit 41 is further arranged to receive a subscription information response sent by the HSS. The subscription information response includes the M2M external identifier, the routing information of the UE retrieved by the HSS according to the identifier of the UE in the underlying network and the identifier of M2M service provider, and the authentication of the CSE in the server searched for by the HSS according to the identifier of CSE in the server.

Preferably, as shown in FIG. 4e and based on the FIG. 4d, the MTC-IWF further includes a first caching unit 46, when the subscription information response is received by the first receiving unit 41, arranged to cache the routing information of the UE and the authentication of the CSE in the server; and

the third sending unit 45 is further arranged to send a registration request to the CSE in the server according to the identifier of CSE in the server. The registration request includes the M2M external identifier of the UE, the application port identifier of the UE and the identifier of the AE.

In an embodiment, as shown in FIG. 4f and based on the FIG. 4e, the first receiving unit 41 is further arranged to receive the equipment triggering request sent by the CSE in the server. The equipment triggering request includes the M2M external identifier of the UE, the application port identifier of the UE and the identifier of the CSE in the server;

the MTC-IWF further includes a searching unit 47, arranged to locally search for the authentication of the CSE, the identifier and routing information of the UE in the underlying network according to the identifier of the CSE in the server and the M2M external identifier of the UE;

the third sending unit 45 is further arranged to feed back an equipment triggering request receipt conformation to the CSE in the server; and

the MTC-IWF further includes a second equipment triggering unit 48, arranged to execute the equipment triggering process in the underlying network according to the authentication of the CSE, the identifier and routing information of the UE in the underlying network.

The MTC-IWF can be implemented by one or multiple servers in actual applications. The first receiving unit 41, the analyzing unit 42, the second sending unit 43, the first equipment triggering unit 44, the third sending unit 45, the searching unit 47 and the second equipment triggering unit 48 can be implemented by a central processing unit (CPU), a digital signal processor (DSP) or a field programmable gate array (FPGA) in the server. The first caching unit 46 can be implemented by a nonvolatile storage medium in the server.

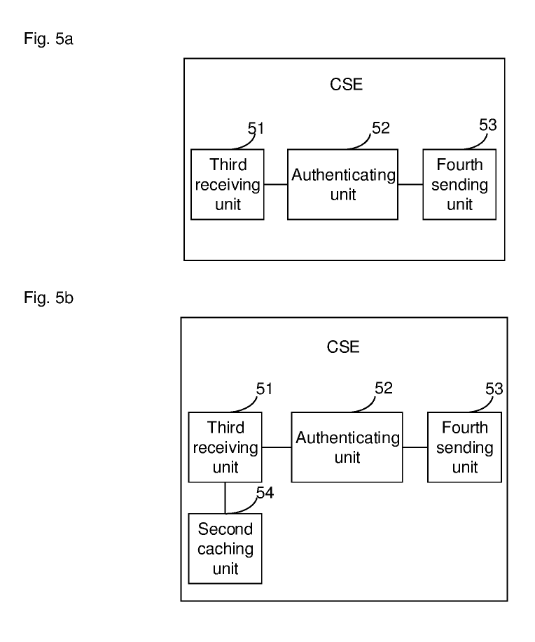

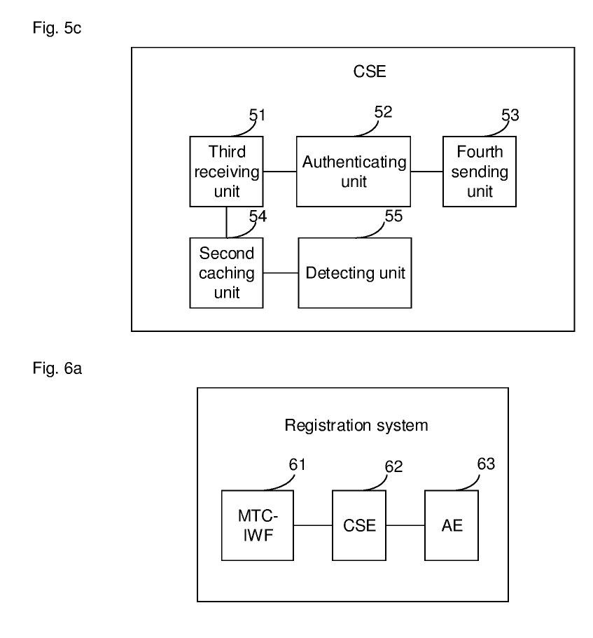

An embodiment of the disclosure further provides a CSE set in a server to which the AE is registered, as shown in FIG. 5a. The CSE includes:

a third receiving unit 51, arranged to receive a registration request sent by MTC-IWF;

an authenticating unit 52, arranged to authenticate the UE; and

a fourth sending unit 53, after the authentication of the authenticating unit 52 is passed, arranged to send the registration request to the AE according to the identifier of the AE. The registration request sent by the fourth sending unit 53 includes the M2M external identifier of the UE and the application port identifier of the UE;

preferably, the third receiving unit 51 is further arranged to receive a registration response. When the registration response is received by the AE, the UE is verified, the verification is passed, the registration response is sent by the AE after the binding relationship between the M2M external identifier of the UE, the application port identifier of the UE and the identifier of the CSE in the UE is determined. The registration response includes the binding relationship between the M2M external identifier of the UE, the application port identifier of the UE and the identifier of the CSE in the UE;

As shown in FIG. 5b and based on FIG. 5a, the CSE further includes a second caching unit 54, arranged to cache the binding relationship and the state information of the UE; and

the fourth sending unit 53 is further arranged to send the equipment registration response to the UE via the MTC-IWF, and the equipment registration response includes the identifier of the CSE in the sever.

In an embodiment, the third receiving unit 51 is further arranged to receive the resource operation request, the resource operation request is sent by the AE when the equipment registration response is sent, by the fourth sending unit 53, to the UE via the MTC-IWF. The resource operation request includes the identifier of CSE in the UE;

as shown in FIG. 5c and based on FIG. 5b, the CSE further includes a detecting unit 55, arranged to detect the state information of the UE according to the identifier of the CSE in the UE; and

the fourth sending unit 53 is further arranged to send the equipment triggering request to the MTC-IWF. The equipment triggering request includes the M2M external identifier of the UE, the application port identifier of the UE and the identifier of the CSE in the server.

The CSE can be implemented by one or multiple servers in actual applications. The third receiving unit 51, the authenticating unit 52, the fourth sending unit 53 and the detecting unit 55 can be implemented by a central processing unit (CPU), a digital signal processor (DSP) or a field programmable gate array (FPGA) in the server. The second caching unit 54 can be implemented by a nonvolatile storage medium in the server.

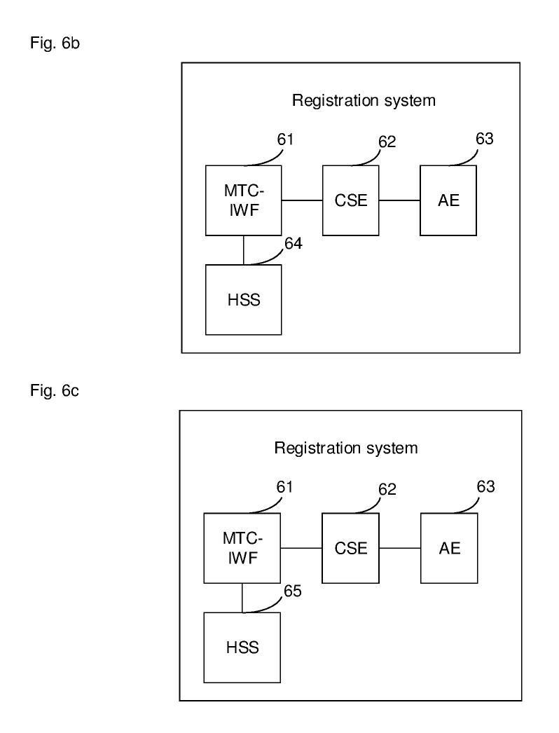

An embodiment of the disclosure further provides a registration system, as shown in FIG. 6a. The system includes: a MTC-IWF 61, a CSE 62 in the UE and a AE 63 of the M2M service provider subscribed to by the UE;

the CSE 62 in the UE is arranged to send an equipment registration request to the MTC-IWF 61. The equipment registration request includes an identifier of the UE in the underlying network, an application port identifier of the UE, an identifier of the M2M service provider subscribed to by the UE, and an identifier of the AE 63 of the M2M service provider;

the MTC-IWF 61 is arranged to receive the equipment registration request.

In an embodiment, as shown in FIG. 6b and based on the FIG. 6a, the system further includes a HSS 64;

the MTC-IWF 61 is further arranged to send a subscription information request to the HSS when the equipment registration request is received. The subscription information request includes the identifier of the UE in the underlying network and the identifier of M2M service provider.

In an embodiment, the HSS 64 is further arranged to, when the subscription information request is received, retrieve the M2M external identifier of the UE according to the identifier of the UE in the underlying network and the identifier of M2M service provider, and feed back the M2M external identifier of the UE to the MTC-IWF 61 through the subscription information response.

In an embodiment, the MTC-IWF 61 is further arranged to, when the subscription information response is received, send the registration request to the CSE 62 in the server according to the identifier of the CSE 62 in the server to which the AE 63 is registered. The registration request includes the M2M external identifier of the UE, the application port identifier of the UE and the identifier of the AE 63.

In an embodiment, the CSE 62 in the server is further arranged to, when the registration request is received, authenticate the UE, and send the registration request to the AE 63 according to the identifier of the AE 63 after the authentication is passed. The registration request includes the M2M external identifier of the UE and the application port identifier of the UE.

In an embodiment, the AE 63 is further arranged to, when the registration request is received, verify the UE, determine the binding relationship between the M2M external identifier of the UE, the application port identifier of the UE and the identifier of the CSE 62 in the UE after the verification is passed, and send the registration response to the CSE 62 in the server. The registration response includes the binding relationship.

In an embodiment, the CSE 62 in the server is further arranged to, when the registration response is received, cache the binding relationship and the state information of the UE, send the equipment registration response to the UE via the MTC-IWF 61. The registration response includes the identifier of the CSE 62 in the server.

In an embodiment, as shown in FIG. 6c and based on the system shown in FIG. 6a, the system further includes a HSS 65;

the MTC-IWF 61 is further arranged to send the subscription information request to the HSS 65 when the equipment registration request is received; the subscription information request includes the identifier of the UE in the underlying network, the identifier of M2M service provider and the identifier of the CSE 62 in the server to which the AE 63 is registered.

In an embodiment, the HSS 65, when the subscription information request is received, is further arranged to retrieve the M2M external identifier and the routing information of the UE according to the identifier of the UE in the underlying network and the identifier of M2M service provider, search the authentication of the CSE 62 in the server according to the identifier of the CSE 62 in the server, and feed back the M2M external identifier, the routing information of the UE and the authentication of the CSE 62 in the server to the MTC-IWF 61 through the subscription information response.

In an embodiment, the MTC-IWF 61 is further arranged to cache the routing information of the UE and the authentication of the CSE 62 in the server when the subscription information response is received, and send the registration request to the CSE 62 in the server according to the identifier of the CSE 62 in the server. The registration request includes the M2M external identifier of the UE, the application port identifier of the UE and the identifier of the AE 63.

In an embodiment, the CSE 62 in the server is further arranged to authenticate the UE when the registration request is received, send the registration request to the AE 63 according to the identifier of the AE 63 after the authentication is passed. The registration request includes the M2M external identifier of the UE and the application port identifier of the UE.

In an embodiment, the AE 63 is further arranged to verify the UE when the registration request is received, determine the binding relationship between the M2M external identifier of the UE, the application port identifier of the UE and the identifier of the CSE 62 in the UE after the verification is passed, and send the registration response to the CSE 62 in the server. The registration response includes the binding relationship.

In an embodiment, the CSE 62 in the server is further arranged to cache the binding relationship and the state information of the UE when the registration response is received, send the equipment registration response to the UE through the MTC-IWF 61. The equipment registration response includes the identifier of the CSE 62 in the server.

In an embodiment, the CSE 62 in the server is further arranged to send the resource operation request to the CSE 62 in the server when the equipment registration response is sent to the UE via the MTC-IWF 61. The resource operation request includes the identifier of the CSE 62 in the server.

In an embodiment, the CSE 62 in the server is further arranged to, after the resource operation request is received, check the state information of the UE according to the identifier of the CSE 62 in the server, send the equipment triggering request to the MTC-IWF 61. The equipment triggering request includes the M2M external identifier of the UE, the application port identifier of the UE and the identifier of the CSE 62 in the server.

In an embodiment, the MTC-IWF 61 is further arranged to, when the equipment triggering request is received, request the authentication of the CSE 62, the identifier and the routing information of the UE in the underlying network from the HSS according to the identifier of the CSE 62 in the server and the M2M external identifier of the UE, or locally search for the authentication of the CSE 62, the identifier and the routing information of the UE in the underlying network according to the identifier of the CSE 62 in the server and the M2M external identifier of the UE; and

further execute the equipment triggering process according to the authentication of the CSE 62, the identifier and the routing information of the UE in the underlying network, and feed back the equipment triggering request receipt confirmation to the CSE 62 in the server.

The user equipment registration method of the disclosure is further described below with reference to specific application scenes.

In a scene 1, the user equipment registration process includes the following steps:

S701: the UE is registered in a network side server when powered on at a first time, and the equipment registration request is sent to the MTC-IWF by the CSE in the UE, the request message including following registration parameters:

1) Device-ID: the identifier of the UE in the underlying network, such as the international mobile subscriber identity (IMSI);

2) Trigger-Recipient-ID: trigger message recipient identifier, which is the application port identifier of the UE;

3) M2M-SP-ID: the identifier of the M2M service provider subscribed to by the UE;

4) AE-ID: the identifier of AE of the M2M service provider, which is the IN-AE identifier;

S702: the equipment registration request of the UE is received by the MTC-IWF, and a subscription information request is sent to the HSS by the MTC-IWF. The request message including the identifier of the UE in the underlying network and the identifier of the M2M service provider;

S703: the subscription information request sent by the MTC-IWF is received by the HSS, the M2M external identifier (M2M-Ext-ID) of corresponding UE is retrieved according to the identifier of the UE in the underlying network and the identifier of the M2M service provider, and then fed back to the MTC-IWF through the subscription information response;

a list of one-to-one mapping relationship between the M2M external identifier of the UE and the identifier of the M2M service provider subscribed to by the UE can be created in an information storage of the HSS in application;

S704: the subscription information response sent by the HSS is received by the MTC-IWF, the identifier of the CSE in the server, to which the AE is registered, is searched for in a local information storage according to the identifier of the AE, which is the identifier of the IN-CSE, and the equipment registration request is sent to the CSE in the server according to the identifier of the CSE in the server; the request message including:

1) M2M-Ext-ID: the M2M external identifier of the UE;

2) Trigger-Recipient-ID: the application port identifier of the UE;

3) AE-ID: the identifier of the AE;

S705: the equipment registration request sent by the MTC-IWF is received by the CSE in the server, after the equipment of the UE is authenticated, the registration request is sent to the AE according to the identifier of the AE; the request message including:

1) M2M-Ext-ID: the M2M external identifier of the UE;

2) Trigger-Recipient-ID: the application port identifier of the UE;

S706: the registration request sent by the CSE in the server is received by the AE, the binding relationship between the M2M external identifier of the UE, the trigger message recipient identifier and the identifier of the CSE in the UE is determined after the registration parameters of the UE are verified, and the registration response is fed back to the CSE in the server. The response message includes the identifier of the CSE in the UE;

a list of the binding relationship between the identifier of the CSE in the UE, which is the ASN/MN-CSE identifier, and the external identifier of the UE, the trigger message recipient identifier can be created in the information storage of the AE in application;

S707: the registration response sent by the AE is received by the CSE in the server, and the state parameters of the UE are cached. The parameters include:

1) CSE-ID: the identifier of the CSE in the UE;

2) M2M-Ext-ID: the M2M external identifier of the UE;

3) Trigger-Recipient-ID: the application port identifier of the UE;

4) State: registration (/connection/sleep/power off/logout);

the equipment registration response is sent to the MTC-IWF. The response message including:

1) M2M-Ext-ID: the M2M external identifier of the UE;

2) Local CSE-ID: the identifier of the CSE in the server;

3) Remote CSE-ID: the identifier of the CSE in the UE (optional parameter);

S708: the equipment registration response sent by the CSE in the server is received by the MTC-IWF, then sent to the CSE in the UE according to the identifier of the UE in the underlying network. The response message including:

1) Device-ID: the identifier of the UE in the underlying network;

2) Remote CSE-ID: the identifier of the CSE in the server;

3) Local CSE-ID: the identifier of the CSE in the UE (optional parameter);

S709: the equipment registration response sent by the MTC-IWF is received by the CSE in the UE, and the registration process is finished;

S710: the resource operation request is sent to the CSE in the server by the AE. The request message includes the identifier of the CSE in the UE;

S711: the information in the request message is cached by the CSE in the server, the state information of the UE is checked according to the identifier of the CSE in the UE, then the equipment triggering request is sent to the MTC-IWF. The request message includes the M2M external identifier of the UE, the application port identifier of the UE and the identifier of the CSE in the server;

S712, according to the identifier of the CSE in the server and the M2M external identifier of the UE, the authentication of the CSE, the identifier and routing information of the UE in the underlying network are requested from the HSS by the MTC-IWF, the equipment triggering request receipt conformation is fed back to the CSE in the server, and the equipment triggering process is executed in the underlying network.

In a scene 2, the user equipment registration process includes the following steps:

S801: the UE is registered in a network side server when powered on at a first time, the equipment registration request is sent to the MTC-IWF by the CSE in the UE. The request message includes following registration parameters:

1) Device-ID: the identifier of the UE in the underlying network, such as the international mobile subscriber identity (IMSI);

2) Trigger-Recipient-ID: trigger message recipient identifier, which is the application port identifier of the UE;

3) M2M-SP-ID: the identifier of the M2M service provider subscribed to by the UE;

4) AE-ID: the identifier of AE of the M2M service provider, which is the IN-AE identifier;

S802: the equipment registration request of the UE is received by the MTC-IWF, the identifier of the CSE in the server, to which the AE is registered, is searched for in an local information storage according to the identifier of the AE, which is the identifier of the IN-CSE, the subscription information request is sent to the HSS. The request message including:

1) Device-ID: the identifier of the UE in the underlying network;

2) M2M-SP-ID: the identifier of the M2M service provider;

3) CSE-ID: the identifier of the CSE in the UE;

S803: the subscription information request sent by the MTC-IWF is received by the HSS, according to the identifier of the UE in the underlying network and the identifier of the M2M service provider, the M2M external identifier (M2M-Ext-ID) and routing information of corresponding UE are retrieved, the authentication of the CSE in the server is searched for according to the identifier of the CSE in the server, and then fed back to the MTC-IWF through the subscription information response;

a list of one-to-one mapping relationship between the M2M external identifier of the UE and the identifier of the M2M service provider subscribed to by the UE can be created in an information storage of the HSS in application;

S804: the subscription information response sent by the HSS is received by the MTC-IWF, the routing information of the UE and the authentication of the CSE in the server are cached, and the equipment registration request is sent to the CSE in the server according to the identifier of the CSE in the server. The request message including:

1) M2M-Ext-ID: the M2M external identifier of the UE;

2) Trigger-Recipient-ID: the application port identifier of the UE;

3) AE-ID: the identifier of the AE;

S805: the equipment registration request sent by the MTC-IWF is received by the CSE in the server, and after the equipment of the UE is authenticated, the registration request is sent to the AE according to the identifier of the AE. The request message includes:

1) M2M-Ext-ID: the M2M external identifier of the UE;

2) Trigger-Recipient-ID: the application port identifier of the UE;

S806: the registration request sent by the CSE in the server is received by the AE, the binding relationship between the M2M external identifier of the UE, the trigger message recipient identifier and the identifier of the CSE in the UE is determined after the registration parameters of the UE are verified, and the registration response is fed back to the CSE in the server. The response message includes the identifier of the CSE in the UE;

the list of the binding relationship list between the identifier of the CSE in the UE, which is the ASN/MN-CSE identifier, and the external identifier of the UE, the trigger message recipient identifier can be created in the information storage of the AE in application;

S807: the registration response sent by the AE is received by the CSE in the server, and the state parameters of the UE are cached, the parameters including:

1) CSE-ID: the identifier of the CSE in the UE;

2) M2M-Ext-ID: the M2M external identifier of the UE;

3) Trigger-Recipient-ID: the application port identifier of the UE;

4) State: registration (/connection/sleep/power off/logout);

the equipment registration response is sent to the MTC-IWF, the response message including:

1) M2M-Ext-ID: the M2M external identifier of the UE;

2) Local CSE-ID: the identifier of the CSE in the server;

3) Remote CSE-ID: the identifier of the CSE in the UE (optional parameter);

S808: the equipment registration response sent by the CSE in the server is received by the MTC-IWF, then sent to the CSE in the UE according to the identifier of the UE in the underlying network. The response message including:

1) Device-ID: the identifier of the UE in the underlying network;

2) Remote CSE-ID: the identifier of the CSE in the server;

3) Local CSE-ID: the identifier of the CSE in the UE (optional parameter);

S809: the equipment registration response sent by the MTC-IWF is received by the CSE in the UE, and the registration process is finished;

S810: the resource operation request is sent to the CSE in the server by the AE. The request message including the identifier of the CSE in the UE;

S811: the information in the request message is cached by the CSE in the server, the state information of the UE is checked according to the identifier of the CSE in the UE, then the equipment triggering request is sent to the MTC-IWF. The request message including the M2M external identifier of the UE, the application port identifier of the UE and the identifier of the CSE in the server;

S812: according to the identifier of the CSE in the server and the M2M external identifier of the UE, the authentication of the CSE, the identifier and routing information of the UE in the underlying network are locally searched for, the equipment triggering request receipt conformation is fed back to the CSE in the server, and the equipment triggering process is executed in the underlying network.

As mentioned above, in the disclosure, the equipment registration request is sent to the MTC-IWF by the CSE in the UE, and the registration request includes the identifier of the UE in the underlying network, the application port identifier of the UE, the identifier of the M2M service provider subscribed to by the UE, and the identifier of the AE of the M2M service provider. Thus, the M2M external identifier of the UE can be requested from the HSS by the MTC-IWF according to the identifier of the UE in the underlying network and the identifier of the M2M service provider subscribed to by the UE, and the M2M external identifier of the UE can be obtained by the CSE in the server in subsequent registration process, so as to finish the registration process of the UE and realize the triggering of the UE by the server.

It is understood by those skilled in the art that: all or part of the steps, implementing the above method, can be implemented using a hardware associated to instructions of a program. The program, which can be stored in a computer readable storage medium, is executed for performing the steps included in the method embodiment above. The storage medium includes all kinds of mediums capable of storing program codes, such as a portable storage device, a random access memory (RAM), a read-only memory (ROM), a disc or an optical disc etc.

Or, when the integrated units of the disclosure are implemented in a form of software functional modules and sold or used as independent products, it can also be stored in a computer readable storage medium. Based on this, the technical solution of the disclosure or the part contributed to related art can be embodied in a form of software product, and the computer software product is stored in a storage medium, including a number of instructions to enable a computer device (it can be a personal computer, a server or a network device etc.) to execute all or part of the method in each embodiment of the disclosure. And the storage medium includes all kinds of mediums capable of storing a program code, such as a portable storage device, a RAM, a ROM, a disc or an optical disc etc.

The above is only the detailed embodiments of the disclosure, not intent to limit the scope of protection of the disclosure, those skilled in the art can make various variations and replacements to the disclosure within the technical range of the disclosure, the variations and replacements fall within the scope of protection of the disclosure. Thus, the scope of protection of the disclosure is the scope of the claims of the disclosure.

1. A user equipment (UE) registration method, comprising:
sending, by a common service entity (CSE) in the UE, an equipment registration request to a machine type communication inter-working function entity (MTC-IWF), wherein the equipment registration request comprises an identifier of the UE in an underlying network, an application port identifier of the UE, an identifier of a machine-to-machine/man (M2M) service provider subscribed to by the UE, and an identifier of an application entity (AE) of the M2M service provider.

2. The method according to claim 1, wherein, when the equipment registration request is received by the MTC-IWF, the method further comprises:
sending, by the MTC-IWF, a subscription information request to a home subscriber server (HSS), wherein the subscription information request comprises the identifier of the UE in the underlying network and the identifier of the M2M service provider.

3. The method according to claim 2, wherein, when the subscription information request is received by the HSS, the method further comprises:
retrieving, by the HSS, a M2M external identifier of the UE according to the identifier of the UE in the underlying network and the identifier of the M2M service provider, and feeding back the M2M external identifier of the UE to the MTC-IWF through a subscription information response.

4. The method according to claim 3, wherein, when the subscription information response is received by the MTC-IWF, the method further comprises:
sending, by the MTC-IWF, a registration request to the CSE in the server according to the identifier of the CSE in the server to which the AE is registered, wherein the registration request comprises the M2M external identifier of the UE, the application port identifier of the UE and the identifier of the AE.

5. The method according to claim 4, wherein, when the registration request is received by the CSE in the server, the method further comprises:
authenticating, by the CSE in the server, the UE, and sending the registration request to the AE according to the identifier of the AE after the authentication is passed, wherein the registration request comprises the M2M external identifier of the UE and the application port identifier of the UE; and
verifying, by the AE, the UE, determining the binding relationship between the M2M external identifier of the UE, the application port identifier of the UE and the identifier of the CSE in the UE after the verification is passed, and sending the registration response to the CSE in the server, wherein the registration response comprises the binding relationship.

6. (canceled)

7. The method according to claim 5, wherein, when the registration response is received by the CSE in the server, the method further comprises:
caching, by the CSE of the server, the binding relationship and state information of the UE, and sending an equipment registration response to the UE via the MTC-IWF, wherein the registration response comprises the identifier of the CSE in the server.

8. The method according to claim 1, wherein, when the equipment registration request is received by the MTC-IWF, the method further comprises:
sending, by the MTC-IWF, a subscription information request to the HSS, wherein the subscription information request comprises the identifier of the UE in the underlying network, the identifier of the M2M service provider and the identifier of the CSE in the server to which the AE is registered.

9.-13. (canceled)

14. The method according to claim 7, wherein, when the equipment registration response is sent, by the CSE of the server, to the UE via the MTC-IWF, the method further comprises:
sending, by the AE, a resource operation request to the CSE of the server, wherein the resource operation request comprises the identifier of CSE in the UE.

15. The method according to claim 14, wherein, after the resource operation request is received by the CSE of the server, the method further comprises:
checking, by the CSE of the server, the state information of the UE according to the identifier of the CSE in the UE, and sending an equipment triggering request to the MTC-IWF, wherein the equipment triggering request comprises the M2M external identifier of the UE, the application port identifier of the UE and the identifier of the CSE in the server.

16. The method according to claim 15, wherein, after the equipment triggering request is received by the MTC-IWF, the method further comprises:
requesting, by the MTC-IWF, the authentication of the CSE, the identifier and routing information of the UE in the underlying network from the HSS according to the identifier of the CSE in the sever and the M2M external identifier of the UE, or locally searching for the authentication of the CSE, the identifier and routing information of the UE in the underlying network according to the identifier of CSE in the sever and the M2M external identifier of the UE; and
executing a triggering process in the underlying network according to the authentication of the CSE, the identifier and routing information of the UE in the underlying network, and feeding back an equipment triggering request receipt confirmation to the CSE in the sever.

17.-29. (canceled)

30. A registration system, wherein the system comprises: a machine type communication inter-working function entity (MTC-IWF), a common service entity (CSE) set in a user equipment (UE), and an application entity (AE) of a machine-to-machine/man (M2M) service provider subscribed to by the UE;
wherein the CSE in the UE is arranged to send an equipment registration request to the MTC-IWF, the equipment registration request comprising an identifier of the UE in an underlying network, an application port identifier of the UE, an identifier of the M2M service provider subscribed to by the UE, and an identifier of the AE of the M2M service provider; and
wherein the MTC-IWF is arranged to receive the equipment registration request.

31. The system according to claim 30, wherein, the system further comprises a home subscriber server (HSS);
the MTC-IWF is further arranged to send a subscription information request to the HSS when the equipment registration request is received, wherein the subscription information request comprises the identifier of the UE in the underlying network and the identifier of M2M service provider; and
the HSS is further arranged to, when the subscription information request is received, retrieve the M2M external identifier of the UE according to the identifier of the UE in the underlying network and the identifier of M2M service provider, and feed back the M2M external identifier of the UE to the MTC-IWF through a subscription information response.

32. (canceled)

33. The system according to claim 31, wherein,
the MTC-IWF is further arranged to, when the subscription information response is received, send the registration request to the CSE in the server according to the identifier of the CSE in the server to which the AE is registered, wherein the registration request comprises the M2M external identifier of the UE, the application port identifier of the UE and the identifier of the AE.

34. The system according to claim 33, wherein,
the CSE in the server is further arranged to, when the registration request is received, authenticate the UE, and send the registration request to the AE according to the identifier of the AE after the authentication is passed, wherein the registration request comprises the M2M external identifier of the UE and the application port identifier of the UE; and
the AE is further arranged to, when the registration request is received, verify the UE, determine the binding relationship between the M2M external identifier of the UE, the application port identifier of the UE and the identifier of the CSE in the UE after the verification is passed, and send the registration response to the CSE in the server, wherein the registration response comprises the binding relationship.

35. (canceled)

36. The system according to claim 34, wherein,
the CSE in the server is further arranged to, when the registration response is received, cache the binding relationship and the state information of the UE, send the equipment registration response to the UE via the MTC-IWF, wherein the registration response comprises the identifier of the CSE in the server.

37. The system according to claim 30, wherein, the system further comprises a HSS;
the MTC-IWF is further arranged to send the subscription information request to the HSS when the equipment registration request is received, wherein the subscription information request comprises the identifier of the UE in the underlying network, the identifier of M2M service provider and the identifier of the CSE in the server to which the AE is registered.

38.-42. (canceled)

43. The system according to claim 36, wherein,
the CSE in the server is further arranged to send a resource operation request to the CSE in the server when the equipment registration response is sent to the UE via the MTC-IWF, wherein the resource operation request comprises the identifier of the CSE in the server.

44. The system according to claim 43, wherein,
the CSE in the server is further arranged to, after the resource operation request is received, check the state information of the UE according to the identifier of the CSE in the server, and send the equipment triggering request to the MTC-IWF, wherein the equipment triggering request comprises the M2M external identifier of the UE, the application port identifier of the UE and the identifier of the CSE in the server.

45. The system according to claim 44, wherein,
the MTC-IWF is further arranged to, when the equipment triggering request is received, request the authentication of the CSE, the identifier and the routing information of the UE in the underlying network from the HSS according to the identifier of the CSE in the server and the M2M external identifier of the UE, or locally search for the authentication of the CSE, the identifier and the routing information of the UE in the underlying network according to the identifier of the CSE in the server and the M2M external identifier of the UE; and
execute an equipment triggering process according to the authentication of the CSE, the identifier and the routing information of the UE in the underlying network, and feed back an equipment triggering request receipt confirmation to the CSE in the server.

46. A computer storage medium for storing computer executable instructions stored, the computer executable instructions being used for executing a user equipment (UE) registration method which comprises:
sending, by a common service entity (CSE) in the UE, an equipment registration request to a machine type communication inter-working function entity (MTC-IWF), wherein the equipment registration request comprises an identifier of the UE in an underlying network, an application port identifier of the UE, an identifier of a machine-to-machine/man (M2M) service provider subscribed to by the UE, and an identifier of an application entity (AE) of the M2M service provider.
